(19) United States
(12) Patent Application Publication
(10) Pub. No.: US 2008/0040590 A1
(43) Pub. Date: Feb. 14, 2008

(54) SELECTIVE BRANCH TARGET BUFFER (BTB) ALLOCAITON

(76) Inventors: Lea Hwang Lee, Austin, TX (US); William C. Moyer, Dripping Springs, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/464,108

(22) Filed: Aug. 11, 2006

(51) Int. Cl. G06F 15/00

(52) U.S. Cl. 712/238

(57) ABSTRACT

Information is processed in a data processing system having a branch target buffer (BTB). In one form, an instruction is received and decoded. A determination is made whether the instruction is a taken branch instruction based on a condition code value set by one of a logical operation, an arithmetic operation or a comparison result of the execution of another instruction or execution of the instruction. An instruction specifier associated with the taken branch instruction is used to determine whether to allocate an entry of the branch target buffer for storing a branch target of the taken branch instruction. In one form the instruction specifier is a field of the instruction. Depending upon the value of the branch target buffer allocation specifier, the instruction fetch unit will not allocate an entry in the branch target buffer for unconditional branch instructions.

### RELATED APPLICATION

This Application is related to Attorney Docket No. NC10097TH by Moyer et al., entitled “METHOD FOR DETERMINING BRANCH TARGET BUFFER (BTB) ALLOCATION FOR BRANCH INSTSRUCTIONS,” filed on even date, and assigned to the current assignee hereof.

### FIELD OF THE INVENTION

The present invention relates generally to data processing systems, and more specifically, to selective branch target buffer (BTB) allocation in a data processing system.

### RELATED ART

Many data processing systems today utilize branch target buffers (BTBs) to improve processor performance by reducing the number of cycles spent in execution of branch instructions. BTBs act as a cache of recent branches and can accelerate branches by providing either a branch target address (address of the branch destination) or one or more instructions at the branch target prior to execution of the branch instruction, which allows a processor to more quickly begin execution of instructions at the branch target address. Typically, for each and every executed branch instruction that is taken, a BTB entry is allocated. This may be reasonable for some BTBs, such as those with a large number of entries, however, for other applications, such as, for example, where cost or speed may limit the size of the BTB, this solution may not achieve sufficient performance improvement.

### BRIEF DESCRIPTION OF THE DRAWINGS

The present invention is illustrated by way of example and not limited by the accompanying figures, in which like references indicate similar elements, and in which:

FIG. 1 illustrates, in block diagram form, a data processing system in accordance with one embodiment of the present invention;

FIG. 2 illustrates, in block diagram form, a portion of a processor of FIG. 1 in accordance with one embodiment of the present invention;

FIG. 3 illustrates a branch instruction executed by the processor of FIG. 2, in accordance with one embodiment of the present invention;

FIG. 4 illustrates, in flow diagram form, a method for selective BTB allocation, in accordance with one embodiment of the present invention;

FIG. 5 illustrates, in flow diagram form, a method for selective BTB allocation with respect to a first and second branch instruction, in accordance with one embodiment of the present invention;

FIG. 6 illustrates a plurality of counters associated with each branch instruction within segment of code in accordance with one embodiment of the present invention;

FIG. 7 illustrates various time snapshots of a list of the last N taken branches of a code segment, in accordance with one embodiment of the present invention;

FIG. 8 illustrates, in flow diagram form, a method for updating the counters of FIG. 6 and the list of the last N taken braches of FIG. 7 in accordance with one embodiment of the present invention; and

FIG. 9 illustrates, in flow diagram form, a method for analyzing branch instructions using the resulting count values determined as a result of the flow of FIG. 8, in accordance with one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE DRAWINGS

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

One embodiment allows for improved performance of a branch target buffer (BTB) by providing the capability of selectively allocating BTB entries based on a BTB allocation specifier which may be associated with each branch instruction (where these branch instructions can be conditional or unconditional branch instructions). Based on this BTB allocation specifier, when a particular branch instruction is taken, an entry may or may not be allocated in the BTB. For example, in some applications, there may be a significant number of branch instructions (including both conditional and unconditional branch instructions) which are infrequently executed or which do not remain in the BTB long enough for reuse, thus lowering the performance of a BTB when the branch target is cached. Therefore, providing the ability to avoid allocating entries for these type of branch instructions, improved processor performance may be obtained. Furthermore, in many low-cost applications, the size of BTBs need to be minimized, thus it is desirable to have improved control over BTB allocations so as not to waste any of the limited number of BTB entries.

Referring to FIG. 1, in one embodiment, a data processing system 10 includes an integrated circuit 12, a system memory 14 and one or more other system module(s) 16. Integrated circuit 12, system memory 14 and one or more other system module(s) 16 are connected via a multiple conductor system bus 18. Within integrated circuit 12 is a processor 20 that is coupled to a multiple conductor internal bus 26 (which may also be referred to as a communication bus). Also connected to internal bus 26 are other internal modules 24 and a bus interface unit 28. Bus interface unit 28 has a first multiple conductor input/output terminal connected to internal bus 26 and a second multiple conductor input/output terminal connected to system bus 18. It should be understood that data processing system 10 is exemplary. Other embodiments include all of the illustrated elements on a single integrated circuit or variations thereof. In other embodiments, only processor 20 may be present. Furthermore, in other embodiments data processing system 10 may be implemented using any number of integrated circuits.

In operation, integrated circuit 12 performs predetermined data processing functions where processor 20 executes processor instructions, including conditional and unconditional branch instructions, and utilizes the other illustrated elements in the performance of the instructions. As will be discussed in more detail below, processor 20 includes a BTB in which entries are selectively allocated based on a BTB allocation specifier.

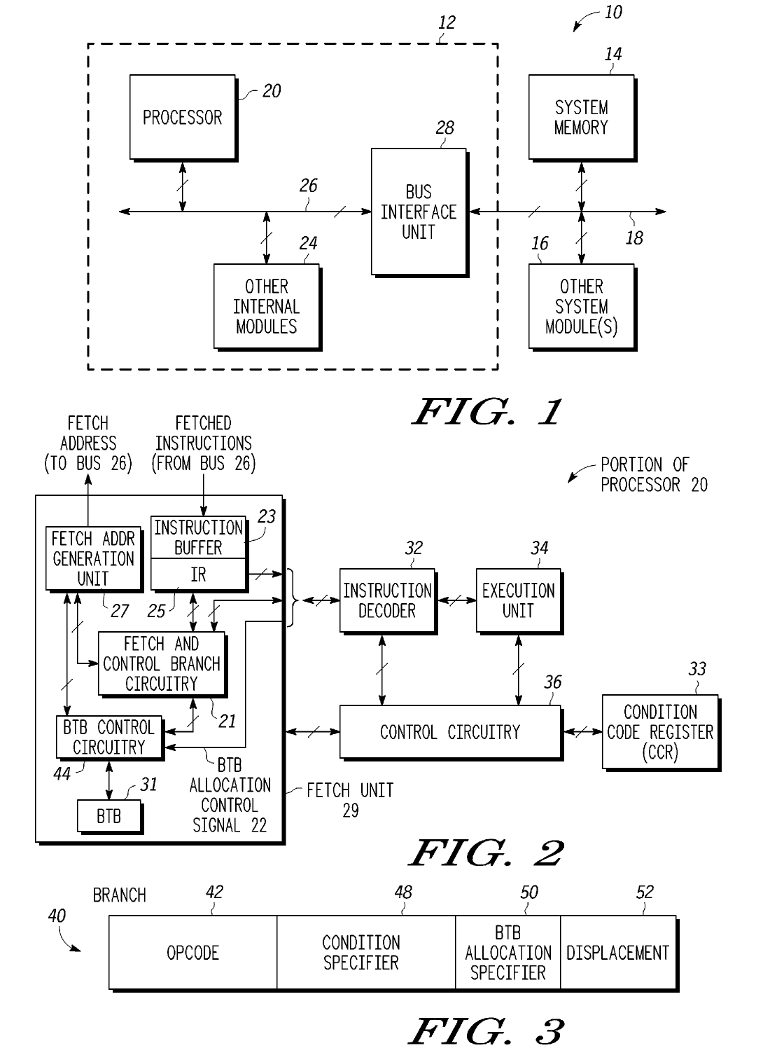

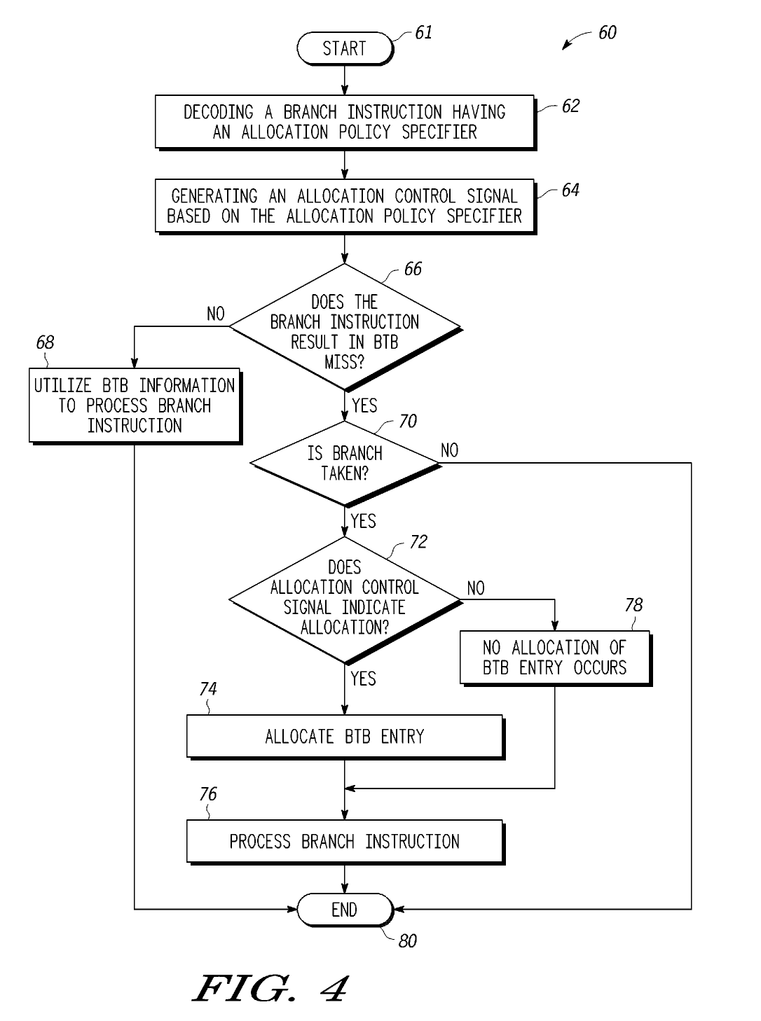

FIG. 2 illustrates a portion of processor 20 in accordance with one embodiment of the present invention. Processor 20 (which may also be referred to as a processing unit) includes an instruction decoder 32, a condition code register (CCR) 33, an execution unit 34 coupled to instruction decoder 32, fetch unit 29 coupled to instruction decoder 32, and control circuitry 36 coupled to CCR 33, fetch unit 29, instruction decoder 32, and execution unit 34. Fetch unit 29 includes a fetch address (addr) generation unit 27, an instruction register (IR) 25, an instruction buffer 23, a BTB 31, BTB control circuitry 44, and fetch and branch circuitry 21. Fetch address generation unit 27 provides fetch address to internal bus 26 and is coupled to fetch and branch control circuitry 21 and BTB control circuitry 44. Instruction buffer 23 is coupled to receive fetched instructions from internal bus 26 and is coupled to provide instructions to IR 25. Instruction buffer 23 and IR 25 are coupled to fetch and branch control circuitry 21, and IR 25 provides instructions to instruction decoder 32. Fetch and branch circuitry 21 is also coupled to instruction decoder 32. BTB control circuitry 44 is coupled to fetch and branch control circuitry 21 and BTB 31, and BTB control circuitry 44 is coupled to receive BTB allocation control signal 22, which, in one embodiment, is provided by instruction decoder 32.

Control circuitry 36 includes circuitry to coordinate, as needed, the fetching, decoding, and execution of instructions, and for reading and updating CCR 33. Typically, CCR 33 stores results of a logical, arithmetic, or compare function. For example, CCR 33 may be a traditional condition code register which stores such condition code values as whether a result of a comparison during the execution of an instruction is zero, negative, results in an overflow, or results in a carry. Alternatively, CCR 33 may be a traditional condition code register which stores condition code values set by an instruction which causes a comparison of two values (or two operands), where the condition code values may indicate that the two values are equal or not equal, or may indicate that one value is greater than or less than the other.

Fetch unit 29 provides fetch addresses to a memory, such as system memory 14, and in return, receives data, such as fetched instructions, which may be stored into instruction buffer 23 and then provided to IR 25. IR 25 then provides instructions to instruction decoder 32 for decoding. After decoding, each instruction gets executed accordingly by execution unit 34. If applicable, some or all of the condition code values of CCR 33 are set by execution unit 34, by way of control circuitry 36, in response to a comparison result of each executed instruction. Execution of some instructions do not affect any of the condition code values of CCR 33, while execution of other instructions may affect some or all of the condition code values of CCR 33. Operation of execution unit 34 and the updating of CCR 33 is known in the art and will therefore not be discussed further herein. Also, operation of fetch address generation unit 27, instruction buffer 23, IR 25, and fetch and branch control circuitry 21 are known in the art. Furthermore, any type of configuration or implementation may be used to implement each of fetch unit 29, instruction decoder 32, execution unit 34, control circuitry 36, and CCR 33.

Also, note that operation of BTB 31 and BTB control circuitry 44 with respect to detecting BTB hits/misses, implementing and providing branch prediction, and providing branch target addresses is also known and will only be discussed to the extent helpful in describing the embodiments herein. In one embodiment, BTB 31 may store branch instruction addresses, corresponding branch targets, and corresponding branch prediction indicators. In one embodiment, the branch target may indicate a branch target address. It may also indicate a next instruction located at the branch target address. The branch prediction indicator may provide a prediction value which indicates whether the branch instruction at the corresponding branch instruction address is to be predicted taken or not taken. In one embodiment, this branch prediction indicator may be a two-bit counter value which is incremented to a higher value to indicate a stronger taken prediction or decremented to a lower value to indicate a weaker taken prediction or to indicate a not-taken prediction. Any other implementation of the branch predictor indicator may be used. In an alternate embodiment, no branch predictor indicator may be present, where, for example, branches which hit in BTB 44 may always be predicted taken.

In one embodiment, each fetch address generated by fetch address generation unit 27 is compared with the entries of BTB 31 by BTB control circuitry 44 to determine if the fetch address hits or misses in BTB 31. If the comparison results in a hit, then it may be assumed that the fetch address corresponds to a branch instruction that is to be fetched. In this case, assuming the branch is to be predicted taken, BTB 31 provides the corresponding branch target to fetch address generation unit 27, via BTB control circuitry 44, such that instructions located at the branch target address can be fetched. If the comparison results in a miss, then BTB 31 cannot be used to provide a predicted branch target quickly. In one embodiment, even if the comparison results in a miss, a branch prediction can still be provided, but the branch target is not provided as quickly as would be provided by BTB 31. Eventually, the branch instruction is actually resolved (by, for example, instruction decoder 32 or execution unit 34) to determine the next instruction to be processed after the branch instruction. If, when resolved, the branch instruction turns out to have been mispredicted, known processing techniques can be used to handle the misprediction.

Referring to instruction decoder 32, in one embodiment, if instruction decoder 32 is decoding a branch instruction, instruction decoder 32 provides a BTB allocation control signal 22 to BTB control circuitry 44 which will be used to help determine whether or not the currently decoded branch instruction is to be stored in BTB 31 on a BTB miss. That is, control signal 22 is used to help determine whether an entry in BTB 31 is allocated for the branch instruction. In one embodiment, the branch instruction being decoded includes a BTB allocation specifier which instruction decoder 32 uses to generate BTB allocation control signal 22. For example, the BTB allocation specifier may be a one-bit field of a branch instruction which when set to a first value, indicates that an entry in BTB 31 is to be allocated on a BTB miss if the branch instruction is determined to be taken, and when set to a second value, indicates that an entry in BTB 31 is not to be allocated on a BTB miss, even if the branch instruction is determined to be taken. That is, the second value would indicate no BTB allocation is to occur. BTB allocation control signal 22 can be generated accordingly, where, for example, signal 22 may be a one-bit signal which when set to a first value, indicates to BTB control circuitry 44 that an entry in BTB 31 is to be allocated on an BTB miss if the corresponding branch instruction is determined to be taken and when set to a second value, indicates that no BTB allocation is to occur for the branch instruction. Therefore, each particular branch instruction within a segment of code can be set to result in BTB allocation or result in no BTB allocation, on a per-instruction basis.

For example, referring to FIG. 3, a sample branch instruction is provided which includes an opcode 42 (which refers to any type of conditional or unconditional branch), a condition specifier 48 (which indicates upon which condition or conditions the branch should be taken, such as, for example, by specifying a condition code), a BTB allocation specifier 50 (which, as described above, indicates whether or not BTB allocation is to occur on a BTB miss if the branch instruction is taken), and a displacement 52 (which is used to generate the branch target address). Displacement 52 may be a positive or negative value which is added to the program counter to provide the a branch target address. Note that in other embodiments, other branch instruction formats may be used. For example, an immediate field may be used to provide the target address rather than a displacement or offset. Alternatively, a subopcode may also be present to further define branch types. The condition specifier may include one or more bits which refer to one or more condition codes or combination of conditions codes, such that the branch instruction is evaluated as true (thus being a taken branch) when the condition specifier is met. Note that the condition values of CCR 33 used to evaluate the branch instruction and determine whether the condition specifier is met may be set by an another instruction (e.g., a previous instruction to the branch instruction) which may, for example, implement a logical, arithmetic or compare operation, or may be set by the branch instruction itself (such as, for example, if opcode 42 specifies a “compare and branch” instruction). Also, opcode 42 may indicate an unconditional branch which is always taken, and therefore, condition specifier 48 may not be present, or may be set to indicate “always branch.” In yet another alternate embodiment, BTB allocation specifier 50 may be included or encoded as part of branch opcode 42. For example, rather than having a particular branch instruction (e.g., branch on equal to zero) having a particular opcode and a BTB allocation specifier which can be set to indicate allocation or no allocation, two separate branch instructions (i.e. two separate opcodes) can be used to differentiate a branch with allocation (e.g. branch on equal to zero with BTB allocation) from a branch without allocation (e.g. branch on equal to zero without BTB allocation).

In yet another embodiment, BTB allocation specifier 50 may not be included as part of the branch instruction itself. For example, in one embodiment, a separate table of allocation specifiers corresponding to the branch instructions may be provided. This table or bit map can be read from memory by, for example, BTB control circuitry 44, for each branch instruction such as from system memory 14, or local memory provided by data processor 12. In this case, BTB allocation control signal 22 may not be provided by instruction decoder 32, but may instead be implicitly or explicitly generated by BTB control circuitry 44 to determine whether or not to allocate an entry in BTB 31. Therefore, a BTB allocation specifier can be provided for each branch instruction, as desired, in a variety of different manners, and is not limited as being included as some part of the branch instruction itself, but instead may reside in any type of data structure located within data processing system 10.

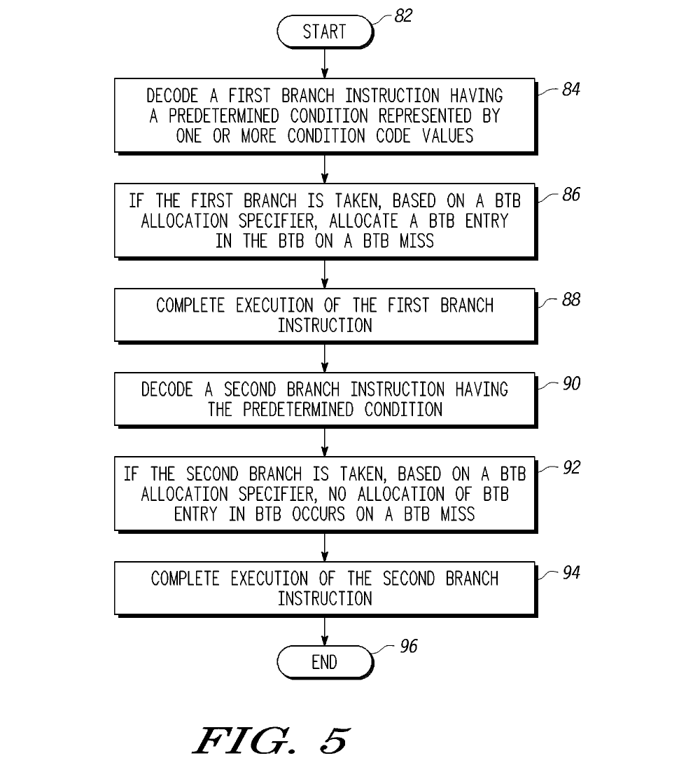

Operation of the BTB allocation specifier, BTB control circuitry 44, and BTB 31 will be discussed further in reference to flow 60 of FIG. 4. Flow 60 begins with start 61 and proceeds to block 62 where a branch instruction having a BTB allocation specifier is decoded. (Note, as discussed above, the BTB allocation specifier can be included as part of the instruction, such as in FIG. 3, where it may be encoded as part of the opcode, or may be provided separately by a table in memory. Also, note that the branch instruction can either be a conditional or unconditional branch, where an unconditional branch is an always taken branch.) Flow proceeds to block 64 where an allocation control signal (such as BTB allocation control signal 22) is generated based on the BTB allocation specifier. Flow proceeds to decision diamond 66 where it is determined whether the branch instruction results in a BTB miss. If not, flow proceeds to block 68 where, as described above, in response to a hit in BTB 31, BTB 31 provides a branch target to fetch address generation unit 27 and possibly, a branch prediction as well. That is, the information provided by BTB 31 in response to a BTB hit is then used to process the branch instruction, as known in the art. Flow then ends at end 80.

However, if, at decision diamond 66, the branch instruction does result in a miss (i.e. it or its instruction address is not located in BTB 31), flow proceeds to decision diamond 70 where it is then determined if the branch instruction is taken or not. This decision is made upon resolving the branch's condition to determine whether or not it is a taken branch. This branch resolution may be performed as known in the art. If the branch results to be not taken, then flow proceeds to end 80 where sequential instruction processing may continue from the branch instruction. However, if the branch results to be taken, then flow proceeds to decision diamond 72 where the allocation control signal is used to determine whether BTB allocation is to occur or not. If the allocation control signal indicates allocation, then a BTB entry is allocated for the branch instruction in block 74. That is, for example, BTB control circuitry 44 allocates an entry in BTB 31 to store the address of the branch instruction, the branch target for the branch instruction, and, in one embodiment, a branch predictor for the branch instruction. Note that in doing so, BTB control circuitry 44 needs to receive the address value for the branch instruction and the branch target. These may be provided by different parts of the processor, depending on how the circuitry and pipeline of processor 20 is implemented. In one example, circuitry within fetch unit 29 (such as, for example, in fetch and branch control circuitry 21), keeps track of the addresses and branch target addresses of each branch instruction. Alternatively, other circuitry (such as, for example, pipeline-like circuitry) located elsewhere within fetch unit 29 or processor 20 may maintain this update information needed when allocating a BTB entry in BTB 31.

After a BTB entry is allocated at block 74, flow proceeds to block 76 where the branch instruction is processed, as known in the art. If, at decision diamond 72, the allocation control signal indicates no allocation, then flow proceeds to block 78 where no allocation of a BTB entry occurs. That is, even though the branch instruction was determined to be taken (at decision diamond 70), the BTB allocation specifier was used to indicate that no entry in BTB 31 is to be allocated at this time for this branch instruction. Therefore, flow proceeds to block 76 where the branch instruction is processed, as known in the art, but without having been stored in BTB 31. Flow then ends at end 80.

FIG. 5 illustrates a method for selective BTB allocation with respect to a first and second branch instruction, each having a BTB allocation specifier, in accordance with one embodiment of the present invention. That is, the method of FIG. 5 illustrates how a BTB allocation specifier can be used for branch instructions to determine, on a per instruction basis, whether or not allocation of a BTB entry occurs. Flow begins with start 82 and proceeds to block 84 where a first branch instruction is decoded (such as by instruction decoder 32), where the first branch instruction has a predetermined condition represented by one or more condition values in a condition code register (such as CCR 33). For example, the predetermined condition can be specified by a condition specifier within the first instruction, such as condition specifier 48 discussed in reference to FIG. 3. The predetermined condition indicates under what condition or conditions (as represented by condition values within the CCR) the first branch instruction is to be taken. The first branch instruction also has a corresponding BTB allocation specifier (which can be provided implicitly or explicitly as part of the first branch instruction itself, as discussed above, or which can be provided by a table or other circuitry) which is set to indicate BTB allocation.

Flow then proceeds to block 86 where, if the first branch is determined to be taken (based on evaluation of the predetermined condition), a BTB entry is allocated in the BTB on a BTB miss (since, as stated above, the BTB allocation specifier corresponding to this first branch instruction indicates BTB allocation). Flow proceeds to block 88 where execution of the first branch instruction is completed.

Flow then proceeds to block 90 where a second branch instruction is decoded (such as by instruction decode 32), where the second branch instruction also has a predetermined condition represented by one or more condition values in a condition code register. Note that the first and second branch instructions may refer to the same or different predetermined condition. However, a BTB allocation specifier corresponding to the second instruction is set to indicate no BTB allocation. Therefore, in one embodiment, the first and second branch instruction can be a same type of branch instruction (in that they have the same opcode such as opcode field 42) but with different BTB allocation specifiers (such as BTB allocation specifier 50). Alternatively, the first and second branch instructions may be different types of branch instructions where the first branch instruction corresponds to a branch-with-allocate instruction while the second branch instruction corresponds to a branch-without-allocate instruction.

Flow then proceeds to block 92 where, if the second branch is determined to be taken (based on evaluation of the predetermined condition), a BTB entry in the BTB is not allocated on a BTB miss (since, as stated above, the BTB allocation specifier corresponding to this second branch instruction indicates no BTB allocation). Flow then proceeds to block 94 where execution of the second instruction is completed. Flow then ends at end 96.

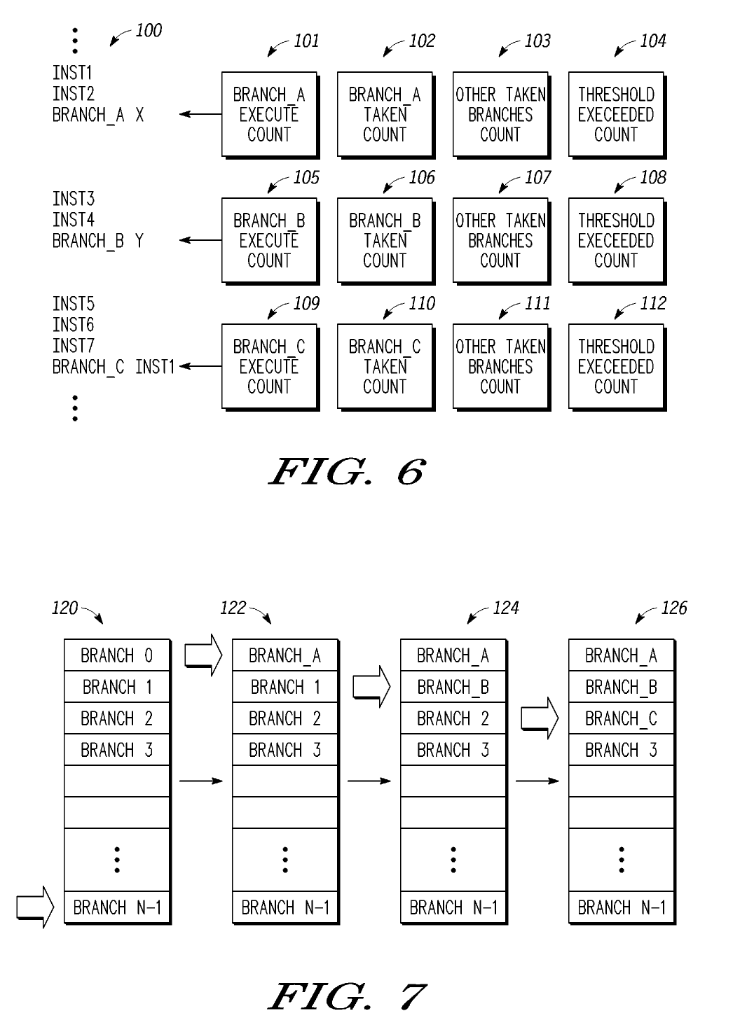

FIGS. 6-9 describe a method of how to mark or encode branch instructions for BTB allocation. That is, the embodiments described in reference to FIGS. 6-9 allow for a determination to be made as to which branch instruction should result in BTB allocation and which should not. Once this is determined, a BTB allocation specifier for each branch instruction can be set accordingly, where this BTB allocation specifier can be as described above. For example, it can be an implicit field within the branch instruction, explicitly encoded within the instruction, can be stored in a separate table read from memory, can be provided in a bit map format for every instruction which allows for an allocation/no allocation choice, etc. Therefore, upon decoding or execution of these branch instructions which have been determined to result in either BTB allocation or no BTB allocation, an appropriate BTB allocation control signal (such as, for example, BTB allocation control signal 22 described above) can be generated. In other embodiments, once particular branch instructions are marked as allocation or no allocation type branch instructions, any mechanism may be used to store this allocation/no allocation information and any mechanism may be used to provide this information appropriately as needed during code execution.

Code profiling may be used to obtain information about code or a segment of code. This information can then be used to, for example, more efficiently structure and compile code for use in its final application. In one embodiment, code profiling is used to control the allocation policy of BTB entries for taken branches (for example, by setting BTB allocation specifiers appropriately to indicate allocation or no allocation for particular branch instructions). In one embodiment, particular factors are combined in a heuristic manner to find a near optimal allocation policy for allocating branches. One factor may the absolute number of times a branch is taken (for example, how frequently a branch is likely to be taken), and the other factor may be the relative percentage of times the branch is not taken within a threshold (Tthresh) number of subsequent branches (for example, this factor may reflect how long a particular branch is likely to remain in the BTB). In one embodiment, the value of Tthresh is a heuristically derived value bounded on the low end by the number of BTB entries and bounded on the high end by two times the number of BTB entries. In one embodiment, the value of Tthresh is used to approximate the capacity of the BTB when conditional allocation is performed. Since not all taken branches will necessarily allocate an entry in the BTB on a BTB miss, the “effective” capacity of the BTB is greater then the number of actual BTB entries. A value of two times the actual number of entries in the BTB implies a 50% allocation rate. In practice, this upper bound is usually more than sufficient, since any greater upper bound implies that many branches are not allocating, which may lower performance. For some specific profiling examples, a value of 1.2 to 1.5 results in near-optimal results. However, other profiling examples may perform better with different values.

In one embodiment, a branch instruction is marked to not allocate a BTB entry if taken if it does not meet a threshold for absolute number of times the branch is taken or if it exceeds the threshold Tthresh more than a certain percentage of times the branch is taken.

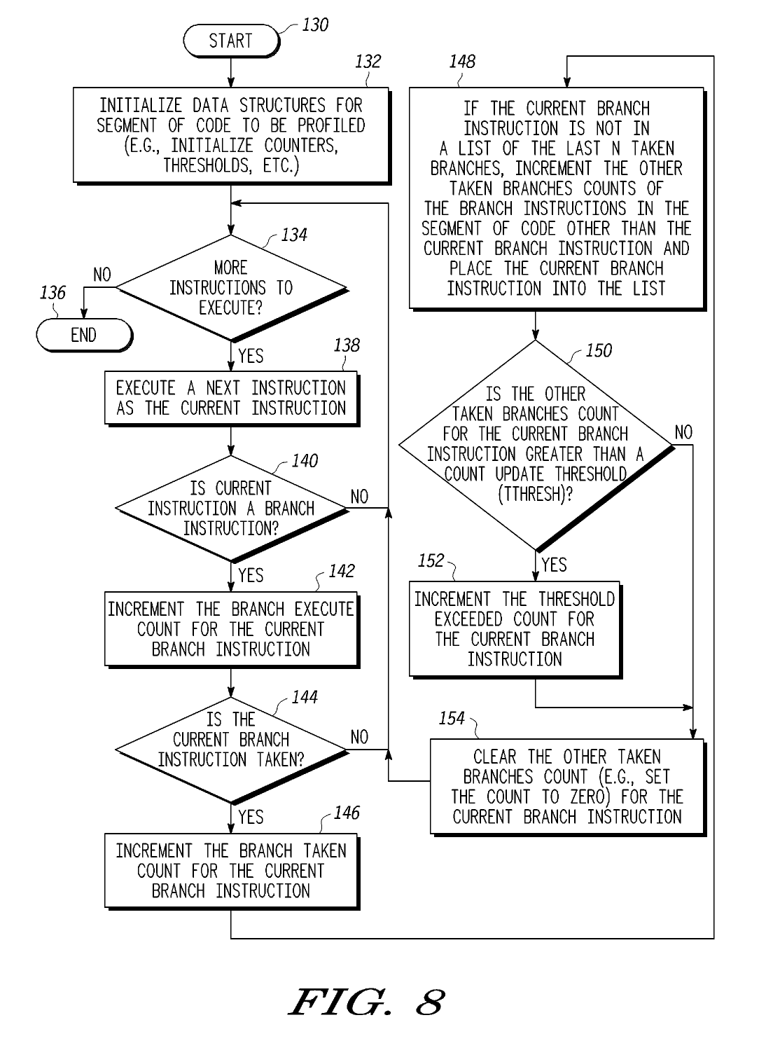

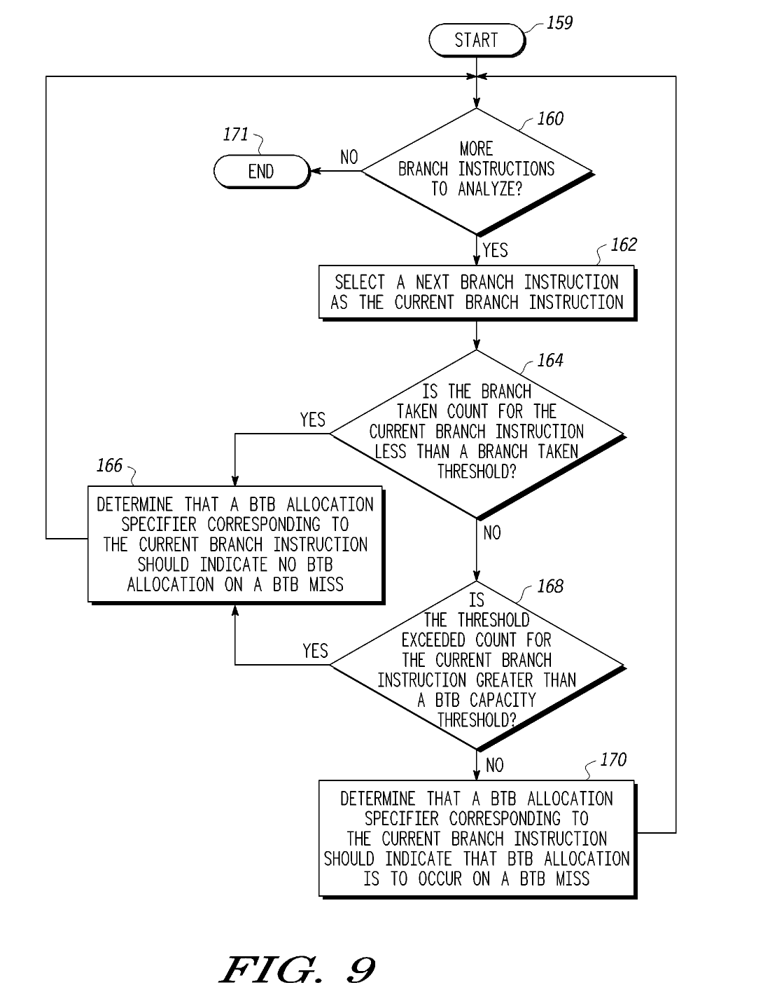

In order to perform the code profiling to control the allocation policy, one embodiment sets up four counters for each branch instruction in a section of code to be analyzed. These counters are illustrated in FIG. 6. For example, in FIG. 6 illustrates a set of four counters for each branch instruction in code segment 100. For example, counters 101-104 correspond to the branch_A instruction, counters 105-108 correspond to the branch_B instruction, and counters 109-112 corresponding to the branch_C instruction. Code segment 100 illustrates a segment of code that is to be profiled (which may include more instructions before INST1 or after the branch_C instruction, as indicated by the dots). This segment may be as small or as large as desired, where each branch instruction being profiled would include the corresponding four counters. The four counters will be described in reference to the branch_A instruction and counters 101-104. Counter 101 is a branch_A execute count which keeps count of the absolute number of times branch_A is executed during execution of code segment 100 (e.g. within a particular timeframe). Counter 102 is branch_A taken count which keeps count of the number of times the branch_A instruction is taken (e.g. within a particular timeframe). Counter 103 is an “other taken branches count” which keeps count of the number of other taken branches which occur between taken occurrences of the branch_A instruction. Counter 104 is a threshold exceeded count which is updated each time branch_A is taken and keeps track of whether the counter 103 exceeds a predetermined threshold. Operation of these counters will be described in more detail in reference to the flow of FIG. 8. Furthermore, the descriptions of counters 101-104 also apply to counters 105-108 and 109-112, respectively, but with respect to the branch_B and branch_C instructions, respectively.

FIG. 7 illustrates a list of the last N taken branches that operates to simulate the BTB. In one embodiment, the list of the last N taken branches operates as a FIFO (first-in first-out queue) where N may be greater than or equal to the number of entries in the BTB. FIG. 7 illustrates four snapshots of the list of the last N taken branches taken at various points in time. List 120 assumes that the FIFO is currently filled with N branches, branch 0 to branch N−1, where the newest taken branch in the FIFO is indicated by a large arrow. If, in profiling code segment 100, it is determined that branch_A is taken, the list of the last N taken branches is updated as shown with list 122, where branch_A takes the place of the oldest branch entry (since the list operates as a FIFO in this example). Therefore, in list 122, the newest taken branch is branch_A, as indicated by the large arrow. If it is then determined that branch_B is taken, the list of the last N taken branches is updated as shown with list 124, where branch_B takes the place of the oldest branch entry at that time, which is branch 1. Therefore, in list 124, the newest taken branch is branch_B, as indicated by the large arrow. Similarly, if it is then determined that branch_C is taken, the list of the last N taken branches is updated as shown with list 126, where branch_C replaces the oldest branch entry at that time, which is branch 2. Therefore, in list 126, the newest taken branch is branch_C, as indicated by the large arrow. The updating of the list of the last N taken branches will also be discussed in more detail in reference to the flow of FIG. 8.

Note that, in one embodiment, counters 101-112 and the list of the last N taken branches can be implemented as software components of a code profiler. Alternatively, they can be implemented in hardware or firmware, or in any combination of hardware, firmware, and software.

The flow of FIG. 8 illustrates a method for updating the counters described above in reference to FIG. 6. Flow begins with start 130 and proceed to block 132 where the data structures for the segment of code to be profiled are initialized. For example, the segment of code to be profiled may refer to code segment 100, and the data structures may include, for example, the counters, thresholds, etc., or any other data structures needed to perform the flow of FIG. 8. For example, the counters may be cleared (i.e. initialized to zero), while the thresholds may be set to predetermined values. Flow then proceeds to decision diamond 134 where it is determined if there are more instructions in the code segment left to execute. If not, then the flow ends at end 136. If so, flow proceeds to block 138 where a next instruction is executed as the current instruction.

Flow then proceeds to decision diamond 140 where it is determined whether the current instruction is a branch instruction (such as, for example, branch_A). If not, flow returns to decision diamond 134. If so, flow proceeds to block 142 where the branch execute count (such as, for example, counter 101) is incremented for the current branch instruction. Flow proceeds to decision diamond 144 where it is determined whether the current branch instruction is taken. If not, then flow returns to decision diamond 134 (where no other counters are updated). If so, then flow proceeds to block 146 where the branch taken counter (such as, for example, counter 102) is incremented for the current branch instruction.

Flow then proceeds to block 148 where, if the current branch instruction is not in a list of the last N taken branches (such as the list described in reference to FIG. 7), the other taken branches counts of the branch instructions in the segment of code other than the current branch instruction (such as counters 107 and 111) are incremented and the current branch instruction is then placed into the list of the last N taken branches. Therefore, note that the other taken branches count for the current branch instruction (such as, for example, counter 103) is not updated when the current branch instruction is being executed, but may be updated when a different branch instruction within the code segment is being executed as the current branch instruction.

Flow then proceeds to decision diamond 150 where it is determined the if the other taken branches count (such as, for example, counter 103) for the current branch instruction is greater than a count update threshold (Tthresh, which was also described above). If so, then flow proceeds to block 152 where the threshold exceeded count (such as, for example, counter 104) for the current branch instruction is incremented. Flow then proceeds to block 154. Similarly, if the result of decision diamond 150 is no, flow proceeds to block 154 (without incrementing the threshold exceeded count for the current branch instruction). At block 154, the other taken branches count (such as, for example, counter 103) for the current branch instruction is cleared (e.g. set to zero). Flow then returns to decision diamond 134 to determine if there are more instructions in the segment of code to execute.

The information gathered by the counters (e.g. counters 101-112) with the flow of FIG. 8 can then be used to mark the branch instructions which should result in BTB allocation and which should not result in BTB allocation. For example, FIG. 9 illustrates a flow which can be used to analyze each branch instruction where the counter values of its corresponding counters can be used to determine whether or not a BTB allocation specifier corresponding to that branch instruction should indicate BTB allocation or no BTB allocation.

The flow of FIG. 9 begins with start 159 and proceeds to decision diamond 160 where it is determined whether or not there are more branch instructions to analyze. If not, the flow ends at end 171. If so, flow proceeds to block 162 where a next branch instruction is selected as the current branch instruction (for example, the current branch instruction may be the branch_A instruction). Flow then proceeds to decision diamond 164 where it is determined if the branch taken count (e.g. final value of counter 102) for the current branch instruction is less than a branch taken threshold (which may be a predetermined threshold set by the user doing the code profiling, depending on the performance needs of the system which is to execute the code). If it does, then flow proceeds to block 166 where it is determined that a BTB allocation specifier corresponding to the current branch instruction should indicate no BTB allocation on a BTB miss. That is, since the branch is not likely to be taken a sufficient number of times, it need not occupy an entry in the BTB, because it will not provide as much value in the BTB as a branch instruction which is taken more times. The branch taken threshold may be experimentally or heuristically determined for each particular instance of code being profiled. For certain code profile examples, a value of one or two for the branch taken threshold may result in near-optimal allocation policies. Other profiling examples may perform better with different values however.

If, at decision diamond 164, the branch taken count is greater than or equal to the branch taken threshold, then flow proceeds to decision diamond 168 where it is determined if the threshold exceeded count (e.g. final value of counter 104, or alternatively, the final value of counter 104 divided by the branch taken count (counter 102 value), representing the relative percentage of times the threshold is exceeded when the branch is taken) for the current branch instruction is greater than a BTB capacity threshold. If so, flow proceeds block 166 where it is also determined that a BTB allocation specifier corresponding to the current branch instruction should indicate no BTB allocation on a BTB miss. That is, in this case, the current branch instruction would likely not exist long enough in the BTB to be of value, due to replacement by BTB allocation by other taken branches executed between instances of this branch being taken, and thus it would be better to not allocate an entry for it and possibly remove a more useful entry.

If, at decision diamond 168, the branch taken count is less than or equal to the BTB capacity threshold, then flow proceeds to block 170 where it is determined that a BTB allocation specifier corresponding to the current branch instruction should indicate that BTB allocation is to occur on a BTB miss. That is, since the current branch instruction is likely to be taken a sufficient number of times, and likely to remain in the BTB long enough for re-use, it is marked such that it does get allocated a BTB entry when taken and a BTB miss occurs. After blocks 166 and 170, flow returns to decision diamond 160 where a next branch instruction, if more exists, is analyzed.

The BTB capacity threshold of decision diamond 168 is generally set to a small value representing the allowable number of times the threshold count was exceeded, or alternatively, when relative percentages are used as the measure, a small percentage representing the maximum allowable percentage of times the threshold count was exceeded, where, in one embodiment, the values range from 10%-30%, although the optimal value for this parameter may be experimentally determined for each code segment for which profiling is desired. In one embodiment, use of counters 102 and 104, the list of the last N taken branches as shown in FIG. 7, and the BTB capacity threshold allows for modeling of BTB activity, in which sufficient new allocations of entries may occur between taken occurrences of the current branch such that even if the current branch allocates a BTB entry, it will have been displaced by the allocation of entries by other branches before the current branch is again taken. In this situation, it may be more advantageous to not allocate an entry for the current branch at all, since a BTB miss is likely to occur anyway the next time the current branch is taken. This is the decision process performed by decision diamond 168, where this decision process provides information with respect to the relative percentage of times the branch is not taken within a threshold (e.g. Tthresh) number of subsequent branches.

After each branch instruction is analyzed and the BTB allocation policy is set for each analyzed branch instruction, the resulting code segment can be structured or compiled accordingly. This may allow for improved performance and improved utilization of the BTB in the processor which will execute the resulting code segment. For example, once code segment 100 is profiled and compiled accordingly, it can be executed by processor 20, which uses the BTB allocation policy specifiers (as described above) to result in improved execution and improved use of BTB 31, especially when BTB space is limited.

Note that the use of these counters simply provides a heuristic for determining whether branch instructions should or should not result in BTB allocation. That is, it is not certain that the instructions meeting or not meeting the above thresholds will be useful or not in the BTB during actual execution of the code segment (e.g. code segment 100) in its final application, such as execution of the code segment by processor 20 described above. However, it can be appreciated how monitoring the factors of how frequently a branch will likely be executed and how long a branch instruction is likely to remain in the BTB prior to being replaced, representing the likelihood that a BTB hit will occur the next time the branch instruction is executed and determined to be taken, an improved allocation policy can be determined and set on a per instruction basis, through the use, for example, of a BTB allocation specifier.

Note that implementations of the above flow charts may be different depending on the application. Furthermore, many of the processes in the flow charts may be combined and done simultaneously or may be expanded into more processes. Therefore, the flow charts described herein are just exemplary. For example, in the decision diamond 164 of FIG. 9, rather than use an absolute count of the number of times the current branch is taken, instead, a percentage of times the branch is taken may be used, and this value may be calculated by dividing the value of the branch taken count (e.g. counter 102, 106, or 110) by the value of the branch execute count (e.g. counter 101, 105, or 109, respectively) for a corresponding branch instruction (e.g. Branch_A, Branch_B, or Branch_C, respectively). In yet another embodiment, a percentage of times the branch is not taken may used, where a counter (similar to counters 102, 106, and 110) may be used to keep track of the number of times the corresponding branch instruction is not taken. Other extensions to the flow process are also intended to be covered by the scope of the present invention.

In one embodiment, a method of processing information in a data processing system in which branch instructions are executed includes receiving and decoding an instruction, determining that the instruction is a taken branch instruction based on a condition code value set by a comparison result of execution of another instruction or execution of the instruction, and using an instruction specifier associated with the taken branch instruction to determine whether to allocate an entry of a branch target buffer for storing a branch target of the taken branch instruction.

In a further embodiment, the method includes decoding the instruction as a compare and branch instruction.

In another further embodiment, the condition code value set by a comparison result of execution of another instruction or execution of the instruction further includes comparing whether two operands are equal or not equal to provide the comparison result.

In another further embodiment, the condition code value set by a comparison result of another instruction or the instruction further includes comparing two values.

In another further embodiment, the method includes implementing the instruction specifier as a predetermined field of the instruction.

In another further embodiment, the condition code value represents one of a carry value, a zero value, a negative value or an overflow value.

In another embodiment, a method includes receiving and decoding a first branch instruction that is either a conditional branch or an unconditional branch, the first branch instruction having a first branch target buffer allocation specifier, if a branch associated with the first branch instruction is taken, allocating a first branch target buffer entry for storing a branch target of the first branch instruction based upon the first branch target buffer allocation specifier, completing execution of the first branch instruction, receiving and decoding a second branch instruction that is either a conditional branch or an unconditional branch, the second branch instruction having a second branch target buffer allocation specifier, if a branch associated with the second branch instruction is taken, deciding not to allocate a second branch target buffer entry for storing a branch target of the second branch instruction based upon the second branch target buffer allocation specifier, and completing execution of the second branch instruction.

In a further embodiment of the another embodiment, the method includes decoding the second branch instruction as an unconditional branch instruction.

In another further embodiment of the another embodiment, the method includes implementing the first branch target buffer allocation specifier and the second branch target buffer allocation specifier as a portion of the first branch instruction and the second branch instruction, respectively.

In another further embodiment of the another embodiment, the method includes at least one of the first branch instruction or the second branch instruction including a conditional branch instruction in which taking a branch during instruction execution is based upon a condition code value in a condition code register. In yet a further embodiment, the method includes determining the condition code value from a comparison result of execution of one of the first branch instruction, the second branch instruction or another instruction by comparing whether two operands are equal or not equal to provide the comparison result. In another yet further embodiment, the method includes determining the condition code value based on an additional instruction implementing a logical, arithmetic or compare operation. In another yet further embodiment, the method includes implementing the condition code value as one of a carry value, a zero value, a negative value or an overflow value.

In one embodiment, a data processing system includes a communication bus, and a processing unit coupled to the communication bus. The processing unit includes an instruction decoder for receiving and decoding instructions, an execution unit coupled to the instruction decoder, an instruction fetch unit coupled to the instruction decoder, the instruction fetch unit comprising a branch target buffer for storing branch targets of branch instructions, a condition code register, and control circuitry coupled to the instruction decoder and the instruction fetch unit, where the instruction fetch unit uses a branch target buffer allocation specifier associated with a received branch instruction to determine whether to allocate an entry of the branch target buffer for storing a branch target of the received branch instruction.

In a further embodiment, the data processing system includes memory coupled to the communication bus, and one or more system modules coupled to the communication bus.

In another further embodiment, the received branch instruction is determined to be a taken branch instruction based on one or more condition code values set by a comparison result of execution of another instruction or the received branch instruction.

In another further embodiment, the received branch instruction is an unconditional branch and the instruction fetch unit does not allocate an entry in the branch target buffer in response to the branch target buffer allocation specifier.

In another further embodiment, the instruction fetch unit receives a first branch instruction, and determines to allocate a branch target buffer entry for the first branch instruction in response to a branch target buffer allocation specifier for the first branch instruction when the first branch instruction is determined to be taken and results in a miss in the branch target buffer. The instruction fetch unit receives a subsequent second branch instruction and does not allocate a branch target buffer entry for the second branch instruction in response to a branch target buffer allocation specifier for the second branch instruction when the second branch instruction is determined to be taken and results in a miss in the branch target buffer.

In another further embodiment, for a same condition indicated by the condition code register, the instruction fetch unit allocates a branch target buffer entry for a first branch instruction when the first branch instruction is taken and results in a miss in the branch target buffer and does not allocate a branch target buffer entry for a second branch instruction when the second branch instruction is taken and results in a miss in the branch target buffer.

In another further embodiment, the condition code register stores values based on an instruction wherein the instruction implements one of a logical, an arithmetic or a compare operation.

In the foregoing specification, the invention has been described with reference to specific embodiments. However, one of ordinary skill in the art appreciates that various modifications and changes can be made without departing from the scope of the present invention as set forth in the claims below. For example, the block diagrams may include different blocks than those illustrated and may have more or less blocks or be arranged differently. Also, the flow diagrams may also be arranged differently, include more or less steps, or may have steps that can be separated into multiple steps or steps that can be performed simultaneously with one another. It should also be understood that all circuitry described herein may be implemented either in silicon or another semiconductor material or alternatively by software code representation of silicon or another semiconductor material. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of processing information in a data processing system in which branch instructions are executed comprising:
receiving and decoding an instruction;
determining that the instruction is a taken branch instruction based on a condition code value set by a comparison result of execution of another instruction or execution of the instruction; and
using an instruction specifier associated with the taken branch instruction to determine whether to allocate an entry of a branch target buffer for storing a branch target of the taken branch instruction.

2. The method of claim 1 further comprising decoding the instruction as a compare and branch instruction.

3. The method of claim 1 wherein the condition code value set by a comparison result of execution of another instruction or execution of the instruction further comprises comparing whether two operands are equal or not equal to provide the comparison result.

4. The method of claim 1 wherein the condition code value set by a comparison result of another instruction or the instruction further comprises comparing two values.

5. The method of claim 1 further comprising:
implementing the instruction specifier as a predetermined field of the instruction.

6. The method of claim 1 wherein the condition code value represents one of a carry value, a zero value, a negative value or an overflow value.

7. A method comprising:
receiving and decoding a first branch instruction that is either a conditional branch or an unconditional branch, the first branch instruction having a first branch target buffer allocation specifier;
if a branch associated with the first branch instruction is taken, allocating a first branch target buffer entry for storing a branch target of the first branch instruction based upon the first branch target buffer allocation specifier;
completing execution of the first branch instruction;
receiving and decoding a second branch instruction that is either a conditional branch or an unconditional branch, the second branch instruction having a second branch target buffer allocation specifier;
if a branch associated with the second branch instruction is taken, deciding not to allocate a second branch target buffer entry for storing a branch target of the second branch instruction based upon the second branch target buffer allocation specifier; and
completing execution of the second branch instruction.

8. The method of claim 7 further comprising decoding the second branch instruction as an unconditional branch instruction.

9. The method of claim 7 further comprising implementing the first branch target buffer allocation specifier and the second branch target buffer allocation specifier as a portion of the first branch instruction and the second branch instruction, respectively.

10. The method of claim 7 further comprising at least one of the first branch instruction or the second branch instruction comprising a conditional branch instruction in which taking a branch during instruction execution is based upon a condition code value in a condition code register.

11. The method of claim 10 further comprising determining the condition code value from a comparison result of execution of one of the first branch instruction, the second branch instruction or another instruction by comparing whether two operands are equal or not equal to provide the comparison result.

12. The method of claim 10 further comprising determining the condition code value based on an additional instruction implementing a logical, arithmetic or compare operation.

13. The method of claim 10 further comprising implementing the condition code value as one of a carry value, a zero value, a negative value or an overflow value.

14. A data processing system comprising:
a communication bus; and
a processing unit coupled to the communication bus, the processing unit comprising:
an instruction decoder for receiving and decoding instructions;
an execution unit coupled to the instruction decoder;
an instruction fetch unit coupled to the instruction decoder, the instruction fetch unit comprising a branch target buffer for storing branch targets of branch instructions;
a condition code register; and
control circuitry coupled to the instruction decoder and the instruction fetch unit,
the instruction fetch unit using a branch target buffer allocation specifier associated with a received branch instruction to determine whether to allocate an entry of the branch target buffer for storing a branch target of the received branch instruction.

15. The data processing system of claim 14 further comprising:
memory coupled to the communication bus; and
one or more system modules coupled to the communication bus.

16. The data processing system of claim 14 wherein the received branch instruction is determined to be a taken branch instruction based on one or more condition code values set by a comparison result of execution of another instruction or the received branch instruction.

17. The data processing system of claim 14 wherein the received branch instruction is an unconditional branch and the instruction fetch unit does not allocate an entry in the branch target buffer in response to the branch target buffer allocation specifier.

18. The data processing system of claim 14 wherein the instruction fetch unit receives a first branch instruction, and determines to allocate a branch target buffer entry for the first branch instruction in response to a branch target buffer allocation specifier for the first branch instruction when the first branch instruction is determined to be taken and results in a miss in the branch target buffer, the instruction fetch unit receiving a subsequent second branch instruction and not allocating a branch target buffer entry for the second branch instruction in response to a branch target buffer allocation specifier for the second branch instruction when the second branch instruction is determined to be taken and results in a miss in the branch target buffer.

19. The data processing system of claim 14 wherein, for a same condition indicated by the condition code register, the instruction fetch unit allocates a branch target buffer entry for a first branch instruction when the first branch instruction is taken and results in a miss in the branch target buffer and does not allocate a branch target buffer entry for a second branch instruction when the second branch instruction is taken and results in a miss in the branch target buffer.

20. The data processing system of claim 14 wherein the condition code register stores values based on an instruction wherein the instruction implements one of a logical, an arithmetic or a compare operation.
